(19) United States
(12) Patent Application Publication
(10) Pub. No.: US 2022/0243100 A1
(43) Pub. Date: Aug. 4, 2022

(54) STRETCH-RELEASABLE TAPES

(71) Applicant: 3M INNOVATIVE PROPERTIES COMPANY, St. Paul, MN (US)

(72) Inventors: Ross J. DeVolder, Woodbury, MN (US); Ramasubramani Kuduva Raman Thanumoorthy, Woodbury, MN (US); Jonathan J. Anderson, New Brighton, MN (US); Sierra V. Trainor, St. Paul, MN (US)

(21) Appl. No.: 17/595,545

(22) PCT Filed: May 14, 2020
(86) PCT No.: PCT/IB2020/054587

§ 371 Date: Nov. 18, 2021

Related U.S. Application Data
(60) Provisional application No. 62/851,964, filed on May 23, 2019.

(51) Int. Cl. C09J 7/38; C09J 7/24; B32B 27/30; B32B 27/18; B32B 27/32; B32B 27/08

(52) U.S. Cl. CPC C09J 7/387; C09J 7/243; B32B 27/302; B32B 27/18; B32B 27/32; B32B 2307/748; C09J 2453/006; C09J 2423/046; B32B 2250/40; B32B 2405/00; B32B 2250/03; B32B 27/08

(57) ABSTRACT

Constructions which may be useful as stretch-release tapes comprise: a first pressure sensitive adhesive (PSA) layer; a support layer; and a second pressure sensitive adhesive (PSA) layer; wherein the support layer comprises: 55-95 wt % of an olefinic copolymer of ethylene and alpha-olefin(s) comprising 3-12 carbons; and 5-45 wt % of a first tackifier. Alternately, the support layer comprises: 55-100 wt % of an olefinic copolymer of ethylene and alpha-octene; and 0-45 wt % of a first tackifier. Alternately, the support layer comprises a first tackifier; the first PSA layer comprises a second tackifier; and the second PSA layer comprises a third tackifier; where the first, second, and third tackifiers are the same tackifier. In some embodiments, first and second PSA layers comprise 30-70 wt % of a styrenic copolymer and 30-70 wt % of a tackifier.

### FIELD OF THE DISCLOSURE

This disclosure relates to constructions including first and second pressure sensitive adhesive (PSA) layers borne on a support layer useful as stretch-release tapes.

### BACKGROUND OF THE DISCLOSURE

The following references may be relevant to the general field of technology of the present disclosure: US 2015/0337177; US 2018/0079937; US 2018/0112110; US 2018/0148618; U.S. Pat. Nos. 6,103,152; 6,797,371; WO 92/011332.

### SUMMARY OF THE DISCLOSURE

Briefly, the present disclosure provides constructions which comprise: a first pressure sensitive adhesive (PSA) layer; a support layer; and a second pressure sensitive adhesive (PSA) layer; wherein the support layer comprises: 55-95 wt % of an olefinic copolymer of ethylene and alpha-olefin(s) comprising 3-12 carbons; and 5-45 wt % of a first tackifier. Alternately, the support layer comprises: 55-100 wt % of an olefinic copolymer of ethylene and alpha-octene; and 0-45 wt % of a first tackifier. Alternately, the support layer comprises a first tackifier; the first PSA layer comprises a second tackifier; and the second PSA layer comprises a third tackifier; where the first, second, and third tackifiers are the same tackifier. In some embodiments, the first PSA layer comprises: 30-70 wt % of a first styrenic copolymer; and 30-70 wt % of a second tackifier. In some embodiments, the second PSA layer comprises: 30-70 wt % of a second styrenic copolymer; and 30-70 wt % of a third tackifier. The first, second and third tackifiers (when present) may be identical or independently different, and in some embodiments are selected from terpene phenolic resins, terpenes, rosin esters, aliphatic-modified C5 to C9 hydrocarbons, aromatic-modified C5 to C9 hydrocarbons and hydrogenated C5 to C9 hydrocarbons. Additional embodiments of the constructions of the present disclosure are described below under “Selected Embodiments.”

The preceding summary of the present disclosure is not intended to describe each embodiment of the present invention. The details of one or more embodiments of the invention are also set forth in the description below. Other features, objects, and advantages of the invention will be apparent from the description and from the claims.

In this application:

“directly bound” refers to two materials that are in direct contact with each other and bound together;

“pressure sensitive adhesive (PSA)” means materials having the following properties: a) tacky surface, b) the ability to adhere with no more than finger pressure, c) the ability to adhere without activation by any energy source, d) sufficient ability to hold onto the intended adherend, and preferably e) sufficient cohesive strength to be removed cleanly from the adherend; which materials typically meet the Dahlquist criterion of having a storage modulus at 1 Hz and room temperature of less than 0.3 MPa; and

“substituted” means, for a chemical species, group or moiety, substituted by conventional substituents which do not interfere with the desired product or process, e.g., substituents can be alkyl, alkoxy, aryl, phenyl, halo (F, Cl, Br, I), cyano, nitro, etc.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### DETAILED DESCRIPTION

The present disclosure provides constructions, typically useful as stretch-release adhesive tapes, comprising: a first pressure sensitive adhesive (PSA) layer; a support layer; and a second pressure sensitive adhesive (PSA) layer. The first and second PSA layers are typically borne on opposite faces of the support layer and directly bound to the support layer. In alternate embodiments, additional layers may be located between one or both PSA layers and the support layer, such as layers of adhesive primer, barrier layers, or foam layers. Stretch release tapes advantageously are capable of high bond strength to adherends, but may be parted from an adherend by stretching. The constructions of the present disclosure may be parted from the adherend by stretching not only in the direction of the bond plane, but also in directions at angles up to 60° or even up to 90° to the bond plane, without tape breakage and without leaving adhesive residue on either adherend.

The constructions according to the present disclosure may have a thickness of 20 to 2000 micrometers, more typically 30 to 1000 micrometers, and more typically 50 to 300 micrometers. The support layer may have a thickness of 10 to 200 micrometers, more typically between 20 and 100 micrometers, and more typically between 25 and 60 micrometers. The PSA layers may have a thickness of 10 to 200 micrometers, more typically between 20 and 100 micrometers, and more typically between 25 and 60 micrometers.

First and second PSA layers may comprise a styrenic copolymer and a tackifier, whose identities and relative amounts may be chosen independently for the first and second PSA layers or may be the same for both PSA layers. The PSA layers may comprise 30-70 wt % of styrenic copolymer, in some such embodiments at least 35 wt % or 40%, and in some such embodiments less than 65 wt % or 60 wt %. The PSA layers may comprise 30-70 wt % of tackifier, in some such embodiments at least 35 wt % or 40%, and in some such embodiments less than 65 wt % or 60 wt %.

Any suitable styrenic copolymer may be used in the first and second PSA layers. A single species or type of styrenic copolymer may be used, or combinations of species or types of styrenic copolymer may be used as the styrenic copolymer. Styrenic copolymers are copolymers of styrene and one or more unsaturated comonomer. Styrene monomers may optionally include substituted styrenes, e.g., alpha-methyl styrene. Comonomers may include singly unsaturated species and/or doubly unsaturated, e.g., 1,3-dienes such as butadiene or isoprene; ethylbutadiene, phenylbutadiene, piperylene, pentadiene, hexadiene, ethylhexadiene and dimethylhexadiene. Comonomers may optionally be substituted. In some embodiments the styrenic copolymers include styrenic block copolymers, in combination with other types or exclusively. Suitable styrenic block copolymers may include A-B block copolymers, A-B-A block copolymers, star block copolymers, and the like. In some embodiments the styrenic copolymers include styrenic random copolymers, in combination with other types or exclusively. In some embodiments the styrenic copolymers include styrene-butadiene-styrene (SBS) block copolymers. In some embodiments the styrenic copolymers include styrene-butadiene random (SBr) copolymers.

In some embodiments, the first PSA layer, second PSA layer, or both may be syntactic or non-syntactic foam adhesive layers. Syntactic foams are composite materials comprising a matrix and dispersed therein hollow structures such as expandable or expanded polymeric microspheres, microballoons, glass microspheres or other flexible- or rigid-walled hollow structures which establish pores within the matrix. Syntactic foams may be generated by addition of hollow structures to the matrix material by any suitable means, including addition of hollow structures to the matrix while it is in a dissolved, melted, or pre-polymeric state. Non-syntactic foams comprise a matrix having pores within the matrix bounded by the matrix material itself. Non-syntactic foams may be generated by creation of pores within the matrix by any suitable means, including addition of physical or chemical blowing agents to the matrix while it is in a dissolved, melted, or pre-polymeric state. In some embodiments, the first PSA layer, second PSA layer, or both may hybrid syntactic/non-syntactic foams.

The support layer may comprise an olefinic polymer or copolymer and in some cases a tackifier. The support layer may comprise 55-100 wt % of olefinic polymer or copolymer, in some embodiments 55-95 wt %, and in some embodiments less than 65 wt % or 60 wt %. The PSA layers may comprise 0-45 wt % of tackifier, in some embodiments 5-45 wt %, and in some embodiments less than 65 wt % or 60 wt %.

Any suitable olefinic polymer or copolymer may be used in the support layer. In some embodiments, the olefinic polymer or copolymer is a random copolymer. In some embodiments, the olefinic polymer or copolymer is a block copolymer. In some embodiments, the olefinic polymer or copolymer is the polymerization product of one or more monomers selected from ethylene, propylene, butylene, pentene, hexene, septene, octene, nonene, decene, undecene, or dodecene. Monomers may optionally be substituted. In some embodiments, the olefinic polymer or copolymer is an olefinic copolymer of ethylene and alpha-olefin(s) comprising 3-12 carbons. In some such embodiments, the alpha-olefin is butylene. In some such embodiments, the alpha-olefin is octene.

Any suitable tackifiers may be used in the various layers of constructions according to the present disclosure. In some embodiments, each tackifier is independently selected from terpene phenolic resins, terpenes, rosin esters, aliphatic-modified C5 to C9 hydrocarbons, aromatic-modified C5 to C9 hydrocarbons and hydrogenated C5 to C9 hydrocarbons. Such tackifiers may include hydrogenated or non-hydrogenated polymers of dicyclopentadiene, non-hydrogenated, partly, selectively or fully hydrogenated hydrocarbon resins based on C5, C5/C9, or C9 monomer streams, polyterpene resins based on alpha-pinene and/or beta-pinene and/or delta-limonene. In various embodiments, useful tackifiers may be solids or liquids at standard temperature and pressure.

PSA layers and support layers may, independently, comprise suitable additives known in the art, which may include plasticizers, fillers, antioxidants, UV stabilizers, pigments, dyes, and the like.

The constructions according to the present disclosure may find particular utility in assembling components of electronic devices and in particular portable electronic devices, due to their strength, resilience, holding ability, repositionability by stretch release. Such electronic devices may include cameras, photography accessories (such as light meters, flash units, lenses, etc.), video cameras, computers or portable computers, calculators, laptops, notebooks, tablet computers, electronic diaries and organizers, modems, computer accessories, mice, drawing pads, graphics tablets, microphones, loudspeakers, gaming consoles, remote controls, touchpads, monitors, displays, screens, touch-sensitive screens, projectors, reading devices for electronic books, mini TV's, pocket TV's, devices for playing films, video players, radios, music players (such as for CD's, DVD's, cassettes, USB, MP3, etc.), headphones, cordless telephones, mobile phones, smart phones, two-way radios, hands-free telephones, pagers, beepers, mobile defibrillators, blood sugar meters, blood pressure monitors, step counters, pulse meters, flashlights, laser pointers, mobile detectors, binoculars, night vision devices, GPS devices, navigation devices, portable interface devices for satellite communications, data storage devices (such as USB sticks, external hard drives, memory cards, etc.), wristwatches, digital watches, pocket watches, chain watches, or stopwatches.

Additional embodiments are recited in the Selected Embodiments and Examples below.

### Selected Embodiments

The following embodiments, designated by letter and number, are intended to further illustrate the present disclosure but should not be construed to unduly limit this disclosure.

C1. A construction comprising:

a. a first pressure sensitive adhesive (PSA) layer;

b. a support layer; and

c. a second pressure sensitive adhesive (PSA) layer;

wherein the support layer comprises:

i. 55-95 wt % of an olefinic copolymer of ethylene and alpha-olefin(s) comprising 3-12 carbons; and

ii. 5-45 wt % of a first tackifier.

C2. The construction according to any of the preceding embodiments wherein the first PSA layer is directly bound to the support layer.
C3. The construction according to any of the preceding embodiments wherein the second PSA layer is directly bound to the support layer.
C4. The construction according to any of the preceding embodiments wherein the first PSA layer comprises:

i. 30-70 wt % of a first styrenic copolymer; and

ii. 30-70 wt % of a second tackifier.

C5. The construction according to any of the preceding embodiments wherein the second PSA layer comprises:

i. 30-70 wt % of a second styrenic copolymer; and

ii. 30-70 wt % of a third tackifier.

C6. The construction according to any of the preceding embodiments wherein the first tackifier is selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.
C7. The construction according to any of the preceding embodiments wherein the first, second, and third tackifiers are independently selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.
C8. The construction according to any of the preceding embodiments wherein the first, second, and third tackifiers are the same.
C9. The construction according to any of the preceding embodiments wherein the alpha-olefin is butylene.
C10. The construction according to any of embodiments C1-C8 wherein the alpha-olefin is octene.
C11. The construction according to any of the preceding embodiments wherein the olefinic copolymer is a random copolymer.
C12. The construction according to any of the preceding embodiments wherein the olefinic copolymer is a block copolymer.
C13. The construction according to any of the preceding embodiments wherein the first and second styrenic copolymers are styrene-butadiene-styrene (SBS) block copolymers.
C14. The construction according to any of the preceding embodiments wherein the first PSA layer is a foam adhesive layer.
C15. The construction according to any of the preceding embodiments wherein the second PSA layer is a foam adhesive layer.
EO1. A construction comprising:

a. a first pressure sensitive adhesive (PSA) layer;

b. a support layer; and

c. a second pressure sensitive adhesive (PSA) layer;

wherein the support layer comprises:

i. 55-100 wt % of an olefinic copolymer of ethylene and alpha-octene; and

ii. 0-45 wt % of a first tackifier.

EO2. The construction according to embodiment EO1 wherein the first PSA layer is directly bound to the support layer.
EO3. The construction according to any of embodiments EO1-EO2 wherein the second PSA layer is directly bound to the support layer.
EO4. The construction according to any of embodiments EO1-EO3 wherein the first PSA layer comprises:

i. 30-70 wt % of a first styrenic copolymer; and

ii. 30-70 wt % of a second tackifier.

EO5. The construction according to any of embodiments EO1-EO4 wherein the second PSA layer comprises:

i. 30-70 wt % of a second styrenic copolymer; and

ii. 30-70 wt % of a third tackifier.

EO6. The construction according to any of embodiments EO1-EO5 wherein the first tackifier is selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.
EO7. The construction according to any of embodiments EO1-EO5 wherein the first, second, and third tackifiers are independently selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.
EO8. The construction according to any of embodiments EO1-EO7 wherein the first, second, and third tackifiers are the same.
EO9. The construction according to any of embodiments EO1-EO8 wherein the olefinic copolymer is a random copolymer.
EO10. The construction according to any of embodiments EO1-EO8 wherein the olefinic copolymer is a block copolymer.
EO11. The construction according to any of embodiments EO1-EO10 wherein the first and second styrenic copolymers are styrene-butadiene-styrene (SBS) block copolymers.
EO12. The construction according to any of embodiments EO1-EO11 wherein the first PSA layer is a foam adhesive layer.
EO13. The construction according to any of embodiments EO1-EO12 wherein the second PSA layer is a foam adhesive layer.
X1. A construction comprising:

a. a first pressure sensitive adhesive (PSA) layer;

b. a support layer; and

c. a second pressure sensitive adhesive (PSA) layer;

wherein the support layer comprises a first tackifier;
wherein the first PSA layer comprises a second tackifier;
wherein the second PSA layer comprises a third tackifier;
and wherein the first, second, and third tackifiers are the same tackifier.
X2. The construction according to embodiment X1,
wherein the support layer comprises 5-45 wt % of the first tackifier;
wherein the first PSA layer comprises 30-70 wt % of the second tackifier; and
wherein the second PSA layer comprises 30-70 wt % of the third tackifier.
X3. The construction according to any of embodiments X1-X2 wherein the first PSA layer is directly bound to the support layer.
X4. The construction according to any of embodiments X1-X3 wherein the second PSA layer is directly bound to the support layer.
X5. The construction according to any of embodiments X1-X4 wherein the first PSA layer additionally comprises 30-70 wt % of a first styrenic copolymer.
X6. The construction according to embodiment X5 wherein the first styrenic copolymer is a styrene-butadiene-styrene (SBS) block copolymer.
X7. The construction according to any of embodiments X1-X6 wherein the second PSA layer additionally comprises 30-70 wt % of a second copolymer.
X8. The construction according to embodiment X7 wherein the second styrenic copolymer is a styrene-butadiene-styrene (SBS) block copolymer.
X9. The construction according to any of embodiments X1-X8 wherein the first, second, and third tackifiers are selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.
X10. The construction according to any of embodiments X1-X9 wherein the support layer additionally comprises 55-100 wt % of an olefinic polymer or copolymer.
X11. The construction according to any of embodiments X1-X9 wherein the support layer additionally comprises 55-100 wt % of an olefinic copolymer of ethylene and alpha-olefin(s) comprising 3-12 carbons.
X12. The construction according to embodiment X11 wherein the alpha-olefin is butylene.
X13. The construction according to embodiment X11 wherein the alpha-olefin is octene.
X14. The construction according to any of embodiments X11-X13 wherein the olefinic copolymer is a random copolymer.
X15. The construction according to any of embodiments X11-X13 wherein the olefinic copolymer is a block copolymer.
X16. The construction according to any of embodiments X11-X15 wherein the first PSA layer is a foam adhesive layer.
X17. The construction according to any of embodiments X11-X16 wherein the second PSA layer is a foam adhesive layer.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

All parts, percentages, ratios, etc. in the examples and the rest of the specification are by weight, unless noted otherwise. The following abbreviations may be used: m=meters; cm=centimeters; mm=millimeters; um=micrometers; ft=feet; in =inch; RPM=revolutions per minute; kg=kilograms; oz=ounces; lb=pounds; Pa=Pascals; sec=seconds; min=minutes; hr=hours; and RH=relative humidity. The terms “weight %”, “% by weight”, and “wt %” are used interchangeably.

| Material | Source |
|---|---|
| Irg1726 | 2,4-Bis(dodecylthiomethyl)-6-methylphenol, an antioxidant available |
| | under the trade designation IRGANOX 1726 available from BASF |
| | Corporation, Florham Park, NJ |
| GP3566 | Styrene-butadiene-styrene block copolymer available under the trade |
| | designation GLOBALPRENE 3566 available from LCY Chemical |
| | Corporation No. 3, Zhonglin Rd., Xiaogang Dist., Kaohsiung City |
| | 812, Taiwan |
| S1205C | Linear random-block styrene-butadiene copolymer with a total content of |
| | 25% styrene under the trade designation SOLPRENE 1205C available |
| | from Dynasol Group, Houston, Tx 77014 |
| A135 | A polyterpene thermoplastic resin tackifier with a softening point |
| | of 135° C. under the trade designation PICCOLYTE A135 available from |
| | Pinova Inc., Brunswick, GA 31520 |
| W10 | A C-5 hydrocarbon resin tackifier with a softening point of 10° C. under |
| | the trade designation WINGTACK 10 from Cray Valley, Exton, PA 19341 |
| LDPE | A low density polyethylene with a melt index of 5.6 grams per 10 |
| | minutes at 190° C. with a 2.16 kg mass. Available under the trade designation |
| | PETROTHANE NA217000 from LyondellBasell, Houston, TX 77010 |
| E8003 | A poly(ethylene-octene) random copolymer polyolefin elastomer |
| | thermoplastic resin available under the trade designation ENGAGE 8003 |
| | available from Dow Inc., Midland, MI 48642 |
| E8402 | A poly(ethylene-octene) random copolymer polyolefin elastomer |
| | thermoplastic resin available under the trade designation ENGAGE 8402 |
| | available from Dow Inc., Midland, MI 48642 |
| I9530 | A poly(ethylene-octene) block copolymer elastomer resin available under |
| | the trade designation INFUSE 9530 from Dow Inc., Midland, MI 48642 |
| Ex9182 | A poly(ethylene-butylene) random copolymer elastomer available under |
| | the trade designation EXACT 9182 from ExxonMobile, Spring, TX 77389 |
| EMS | Heat-expandable polymeric microspheres having an average pre- |
| | expanded particle diameter of 6-11 μm under the trade designation |
| | MASTUMOTO FN-100SSD. Available from Matsumoto, Yao-shi, Osaka, Japan. |
| Test Panel 1 | Type 304 mirror-finished, stainless steel panel cut to the dimension of |
| | 50.8 mm (2 inches) by 127 mm (5 inches) by 0.12 cm thick (0.0472 |
| | inches). Available from Cheminstruments, Fairfield, OH. |
| P5413 | A Dupont Kapton polyimide film tape with a silicone pressure sensitive |
| | adhesive coated onto it. Available under the trade designation 3M |
| | POLYIMIDE FILM TAPE 5413 AMBER from 3M Company, St. Paul, MN 55144 |
| Release Liner 1 | A 0.003 in. (75 micrometer) thick polyester release liner having a |
| | different release coating on each side to provide a differential release. |
| Tissue paper | Trade designation KIMWIPE, available from Kimberly-Clark |
| | Corporation, Irving, TX |

### Test Methods

### Stretch Release Test

P5413 tape was bonded to Test Panel 1, with the polyimide face of the P5413 tape facing outward, forming a rigid film surface. Tape samples were cut into 12 mm (0.472 in) wide strips having a bonding area of 789.5 mm² (1.22 in²) and were laminated to the polyimide face of the rigid film surface. A 4.5 kg roller was rolled over the laminated tape strips 5 times to ensure bonding to the rigid P5413 surface. Next, Release Liner 1 was removed from the tape sample and a bare Test Panel 1 was laminated to the backside of the tape, subsequently forming a joint bond between the two test panels and tape sample. A 6 kg weight was applied to the bonded constructs for 15 seconds and the bonded article was allowed to dwell for 1 hour at 23° C. and 50% relative humidity. Next, a 529.9 mm² (0.82 in²) tab region of the tape strip, projecting out from the joint bond was pulled at 60° angle with respect to the bond plane, at a rate of 304.8 mm/min (12 in/min) using a Sintech 500/S (available from MTS, Eagan, Minn.). Samples that cleanly released from the bonded construct were recorded. For samples that did not stretch release and a bond remained, the height at which the samples broke or failed was recorded.

### Peel Adhesion Test

Samples were prepared by slitting uniform test strips 12.7 mm×127 mm (0.5 inches×5 inches) in dimension from each adhesive tape samples prepared. Two replicates were prepared for each Example and Comparative Example tape sample. Then the exposed adhesive surface of the test strips were adhered along the length of a stainless steel (SS) plate measuring 5.1 cm (2 inches) wide by 12.7 cm (5 inches) long by 0.12 cm thick (0.0472 inches) and rolled down 5 times with a 2.0 kg rubber roller. The plate was cleaned prior to applying the tape by wiping with acetone once, then with heptane three times using a tissue paper. After being conditioned for 72 hours at 50% relative humidity (RH) at 23° C. (RT), the peel adhesion strength was evaluated using a tensile tester Sintech 500/S, using a crosshead speed of 304.8 mm/min (12 in/min), at an angle of 180° with the test specimen held in the bottom clamp and the tail in the top clamp. The average of the two test specimens was reported in N/decimeter (N/dm). This number was reported as the “Peel on SS after 72 hrs RT Dwell”.

### Examples 1-6 (E1-E6)

Examples 1-6 were multilayer samples having an ABA construction. For all samples, melt stream Layer A was compounded using a 25 mm co-rotating twin screw extruder (available from Berstorff) having the compositions found in Table 1. Melt stream Layer A was compounded according to the following procedure with a 3.63 kg/hr (8 lb/hr) throughput found in Table 3. GP3566 was dry fed into the first zone of the 25 mm co-rotating twin screw extruder. Resin W10 was heated to 93.3° C. (200° F.) and fed into the fourth zone of the extruder for Layer A using a gridmelter (available from Dynatec). Resin A135 was heated to 176.7° C. (350° F.) and fed into the sixth zone of the extruder for Layer A using a gridmelter (available from Dynatec). EMS was fed into the eighth zone of the extruder for Layer A, using a loss-in-weight feeder (available from Brabender). The compounded melt stream Layer A was metered using a gear-pump (available from Colfax), and then evenly split into two melt streams, each having a throughput of 1.81 kg/hr (4 lb/hr). For all samples, melt stream Layer B was compounded using an 18 mm co-rotating twin screw extruder (available from ThermoScientific) having the compositions found in Table 2. Melt stream Layer B was compounded according to the following procedure with a 1.81 kg/hr (4 lb/hr) throughput found in Table 3. All components, E8003, A135, W10, E8402, 19530, and/or Ex9182, were fed into the first zone of the extruder, compounded, and metered using a gear-pump (available from Colfax). All extrudate melt streams were fed into a multi-layer feedblock (available from Nordson and/or Cloeron) and were merged forming an ABA multilayer melt stream with layer combinations found in Table 3. The ABA multilayer stream was passed through a single layer die (available from Nordson and/or Cloeron) and cast onto Release Liner 1 with a 150 um (5.9 mil) thickness.

### Comparative Example 1 (C1)

Comparative Example 1 was prepared using the same procedure as Examples 1-7. The compositions of melt stream Layer A and B are found in Table 1 and Table 2, respectively. The layer throughputs and combination for C1 are found in Table 3.

TABLE 1
Layer A composition

| Name | GP3566 | A135 | W10 | EMS | Irg1726 |
|---|---|---|---|---|---|
| PSAComp1 | 50% | 45% | 2.5% | 2% | 0.5% |

TABLE 2
Layer B compositions

| Name | E8003 | A135 | W10 | E8402 | I9530 | Ex9182 | LDPE |
|---|---|---|---|---|---|---|---|
| CoreComp1 | 65% | 35% | | | | | |
| CoreComp2 | 80% | | 20% | | | | |
| CoreComp3 | | | | 100% | | | |
| CoreComp4 | | 10% | | | 90% | | |
| CoreComp5 | | 35% | | | | 65% | |
| CoreComp6 | | | 15% | | | 85% | |
| CoreComp7 | | | | | | | 100% |

TABLE 3
Melt stream throughputs and layer combinations

| | Layer A | | Layer B | |
|---|---|---|---|---|
| | | Mass Flow | | Mass Flow |
| | | Rate | | Rate |
| Example | Material | kg/hr (lbs/hr) | Material | kg/hr (lbs/hr) |
| E1 | PSAComp1 | 3.63 (8) | CoreComp1 | 1.81 (4) |
| E2 | PSAComp1 | 3.63 (8) | CoreComp2 | 1.81 (4) |
| E3 | PSAComp1 | 3.63 (8) | CoreComp3 | 1.81 (4) |
| E4 | PSAComp1 | 3.63 (8) | CoreComp4 | 1.81 (4) |
| E5 | PSAComp1 | 3.63 (8) | CoreComp5 | 1.81 (4) |
| E6 | PSAComp1 | 3.63 (8) | CoreComp6 | 1.81 (4) |
| C1 | PSAComp1 | 3.63 (8) | CoreComp7 | 1.81 (4) |

### Results

Stretch release and peel adhesion testing results are displayed in Table 4. Examples 1-6 containing polyethylene-based elastomer resins in the core layer of an ABA multi-layer construction demonstrate the embodiments of the present disclosure by providing significantly improved stretch release performance, compared to the example containing a traditional thermoplastic resin of polyethylene. Additionally, the peel adhesion force demonstrates the applicability of these constructions for a variety of bonding solutions.

TABLE 4
Peel Adhesion and Stretch Release Measurements

| | Stretch Release | | Peel on SS after |
|---|---|---|---|
| Example | Pass/Fail | Percent Removed | 72 hrs RT Dwell (N/dm) |
| E1 | Pass | 100% | 160 |
| E2 | Pass | 100% | 90 |
| E3 | Pass | 100% | 110 |
| E4 | Pass | 100% | 90 |
| E5 | Pass | 100% | 140 |
| E6 | Pass | 100% | 90 |
| C1 | Fail | 5% | 120 |

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A construction comprising:
a. a first pressure sensitive adhesive (PSA) layer;
b. a support layer; and
c. a second pressure sensitive adhesive (PSA) layer;
wherein the support layer comprises:
i. 55-95 wt % of an olefinic copolymer of ethylene and alpha-olefin(s) comprising 3-12 carbons; and
ii. 5-45 wt % of a first tackifier.

2. The construction according to claim 1 wherein the first PSA layer comprises:
i. 30-70 wt % of a first styrenic copolymer; and
ii. 30-70 wt % of a second tackifier.

3. The construction according to claim 1 wherein the second PSA layer comprises:
i. 30-70 wt % of a second styrenic copolymer; and
ii. 30-70 wt % of a third tackifier.

4. The construction according to claim 1 wherein the first tackifier is selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.

5. The construction according to claim 1 wherein each tackifier is independently selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.

6. The construction according to claim 1 wherein all tackifiers are the same.

7. The construction according to claim 1 wherein the alpha-olefin is butylene.

8. The construction according to claim 1 wherein the alpha-olefin is octene.

9. The construction according to claim 1 wherein the olefinic copolymer is a random copolymer.

10. The construction according to claim 1 wherein the olefinic copolymer is a block copolymer.

11. The construction according to claim 1 wherein the first and second styrenic copolymers comprise styrene-butadiene-styrene (SBS) block copolymers.

12. A construction comprising:
a. a first pressure sensitive adhesive (PSA) layer;
b. a support layer; and
c. a second pressure sensitive adhesive (PSA) layer;
wherein the support layer comprises:
i. 55-100 wt % of an olefinic copolymer of ethylene and alpha-octene; and
ii. 0-45 wt % of a first tackifier.

13. The construction according to claim 12 wherein the first PSA layer comprises:
i. 30-70 wt % of a first styrenic copolymer; and
ii. 30-70 wt % of a second tackifier.

14. The construction according to claim 12 wherein the second PSA layer comprises:
i. 30-70 wt % of a second styrenic copolymer; and
ii. 30-70 wt % of a third tackifier.

15. The construction according to claim 12 wherein the first tackifier is selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.

16. The construction according to claim 12 wherein the each tackifier is independently selected from the group consisting of terpene phenolic resins, terpenes, rosin esters, aliphatic-modified C5 to C9 hydrocarbons, aromatic-modified C5 to C9 hydrocarbons and hydrogenated C5 to C9 hydrocarbons.

17. The construction according to claim 12 wherein all tackifiers are the same.

18. The construction according to any of claim 12 wherein the olefinic copolymer is a random copolymer.

19. The construction according to claim 12 wherein the olefinic copolymer is a block copolymer.

20. The construction according to claim 12 wherein each styrenic copolymer comprises a styrene-butadiene-styrene (SBS) block copolymer.
